(19) United States
(12) Patent Application Publication
(10) Pub. No.: US 2006/0175851 A1
(43) Pub. Date: Aug. 10, 2006

(54) Aircraft cargo hook

(76) Inventor: Donn J. Snyder, Boring, OR (US)

Correspondence Address: SMITH-HILL AND BEDELL, P.C., 16100 NW CORNELL ROAD, SUITE 220, BEAVERTON, OR, 97006, US

(21) Appl. No.: 11/051,276

(22) Filed: Feb. 4, 2005

(51) Int. Cl. B66C 1/34

(52) U.S. Cl. 294/82.33

(57) ABSTRACT

A cargo hook for an aircraft includes a load beam mounted in a housing and pivotable relative to the housing between a closed position and an open position. A lock mechanism includes a release member that is pivotable relative to the housing between a released position, in which the lock mechanism permits pivotal movement of the load beam from its closed position to its open position, and a locked position, in which the lock mechanism prevents movement of the load beam from its closed position to its open position. A sensor senses whether the release member is in the locked position and an indicator circuit provides different respective indications when the sensor senses that the release member is in the locked position and when the sensor does not sense that the release member is in the locked position.

### BACKGROUND OF THE INVENTION

A conventional keeperless cargo hook for suspending a load from an aircraft includes a housing that is provided with bushings to facilitate attachment to a mount point on the aircraft and a load beam that is attached to the housing in a manner that allows the beam to pivot relative to the housing between an open position, in which a distal end of the load beam is spaced from the housing and a load ring attached to a load can be placed on the load beam, and a closed position, in which the distal end of the load beam is positioned between two extensions of the housing and the load ring is captive between the load beam and the housing. The cargo hook includes a lock mechanism for locking the load beam in its closed position. The lock mechanism has a locked state, in which it holds the load beam in its closed position, and a released state in which it allows the load beam to pivot from the closed position to the open position.

In one keeperless cargo hook that is commercially available from Onboard Systems, Inc. of Vancouver, Wash., the load beam is generally U-shaped and is pivoted at a location near the base of the U. The lock mechanism includes a toggle assembly that is pivotable within the housing between a locked position, in which an end of the toggle assembly engages the upper arm of the load beam and holds the load beam in the closed position, and a released position in which the toggle assembly permits pivotal movement of the load beam under gravity from the closed position to the open position. The lock mechanism also includes a release cam member that is pivotable in the housing against the force of a spring from a locked position to a released position. When the toggle assembly is in the locked position and the release cam member is in the locked position, two cam arms of the release cam member prevent pivotal movement of the toggle assembly to the released position. When the release cam member is pivoted from the locked position to the released position, the toggle assembly is free to pivot towards its released position and is driven towards the released position by the load beam in the event that the load beam pivots toward the open position. If the load beam pivots towards the open position, the load beam interacts with the release cam member and prevents it from returning to the locked position.

When the load beam is in the open position, a load ring can be placed on the lower limb of the load beam. The load beam is then pivoted towards the closed position. The load ring is pushed upwards, against the underside of the upper limb of the load beam, and interaction between the load beam and the toggle assembly forces the toggle assembly to pivot from its locked position towards its released position and allow the load beam to complete its movement to the closed position. The toggle assembly then returns to its locked position. The pivotal movement of the load beam towards its closed position results in the release cam mechanism being pivoted towards its locked position. In the final phase of pivotal movement of the load beam towards its closed position, the release cam member arrives at its locked position and the cam arms once more engage the toggle assembly and prevent pivotal movement of the toggle assembly to the released position.

The conventional cargo hook that is referred to above includes a solenoid that interacts with the release cam member when the lock mechanism is in the locked state for transferring the lock mechanism to the released state, in which it allows the load beam to pivot from the closed position to the open position and release the load ring. Supply of energizing current to the solenoid is controlled by a control switch that is located in the aircraft cockpit and is connected to the cargo hook by a flexible cable. When the pilot operates the control switch, the solenoid is energized briefly and turns the release cam member from the locked position towards the released position and allows the toggle assembly to turn from its locked position to its released position.

Current regulations require that a cargo hook have two independent release mechanisms and that one of the release mechanisms is not electrical. It is known to provide the cargo hook with a secondary release mechanism employing a mechanical push-pull cable in order to meet this requirement. The push-pull cable includes a sleeve and a core that is slidable within the sleeve and is connected at one end of the cable to the lock mechanism and at the other end of the cable to a manual actuator in the aircraft cockpit. When the pilot applies an appropriate manual effort to the actuator, the core of the push-pull cable transmits the effort to the lock mechanism and transfers the lock mechanism to the released state. Such a secondary control, employing a mechanical push-pull cable, is subject to disadvantage because of the possibility of, for example, improper rigging of the cable, kinking of the cable or jamming of the core of the cable in its sleeve. In this event, the pilot may be unable to cause the cargo hook to release the load in a controlled fashion, and this may result in damage to the aircraft, damage to the load and injury to people on the ground. Inability to release the load may also place the aircraft in an unsafe condition for flight.

While it is important that the cargo hook be operable to release the load in controlled fashion, it is also important for the pilot and ground personnel to have reliable information regarding whether the load beam is properly locked in the closed position, so that the cargo hook will not unexpectedly release the load when the aircraft takes off.

Since the lock mechanism is located in the housing, it is not visible to the ground personnel who are responsible for attaching the load to the cargo hook. Consequently, the ground personnel, who can readily see the load beam, are likely to assume that the load beam is locked in the event that the load beam appears to be in the closed position. However, in the unlikely event that the lock mechanism malfunctions, for example due to the release cam member jamming near the released position, the load beam might not be fully locked, and should the ground personnel then signal to the pilot that the cargo hook is closed it is possible that when the aircraft takes off, the load beam will pivot to the open position and the cargo hook will then drop the load.

### SUMMARY OF THE INVENTION

In accordance with a first aspect of the present invention there is provided a cargo hook for an aircraft, comprising a housing, a load beam mounted in the housing and pivotable relative to the housing between a closed position and an open position, a lock mechanism including a release member that is pivotable relative to the housing between a released position, in which the lock mechanism permits pivotal movement of the load beam from its closed position to its open position, and a locked position, in which the lock mechanism prevents movement of the load beam from its closed position to its open position, a sensor for sensing whether the release member is in the locked position, and an indicator circuit for providing different respective indications when the sensor senses that the release member is in the locked position and when the sensor does not sense that the release member is in the locked position.

In accordance with a second aspect of the present invention there is provided an aircraft cargo hook installation comprising a cargo hook including a housing, a load beam mounted in the housing and pivotable relative to the housing between a closed position and an open position, a lock mechanism including a release member that is pivotable relative to the housing between a released position, in which the lock mechanism permits pivotal movement of the load beam from its closed position to its open position, and a locked position, in which the lock mechanism prevents movement of the load beam from its closed position to its open position, and a sensor for sensing whether the release member is in the locked position, and a display located interiorly of the aircraft and connected operatively to the sensor for providing different respective indications when the sensor senses that the release member is in the locked position and when the sensor does not sense that the release member is in the locked position.

In accordance with a third aspect of the present invention there is provided an aircraft cargo hook installation comprising a cargo hook including a housing, a load beam mounted in the housing and pivotable relative to the housing between a closed position and an open position, and a lock mechanism including a release member that is movable relative to the housing between a released position, in which the lock mechanism permits pivotal movement of the load beam from its closed position to its open position, and a locked position, in which the lock mechanism prevents movement of the load beam from its closed position to its open position, a slave hydraulic cylinder attached to the housing and having a piston that is in force transmitting relationship with the release member when the release member is in the locked position and the slave hydraulic cylinder is actuated, for moving the release member to its released position, a master hydraulic cylinder that can be actuated from a location interiorly of the aircraft, and an hydraulic hose connecting the master hydraulic cylinder to the slave hydraulic cylinder for communicating hydraulic pressure between the master hydraulic cylinder and the slave hydraulic cylinder, whereby actuation of the master hydraulic cylinder effects actuation of the slave hydraulic cylinder.

### BRIEF DESCRIPTION OF THE DRAWINGS

For a better understanding of the invention, and to show how the same may be carried into effect, reference will now be made, by way of example, to the accompanying drawings, in which

FIG. 1 is a perspective view of a cargo hook embodying the present invention and illustrates a housing, a load beam and a solenoid assembly,

FIG. 2 is a partial perspective view of the hook with the solenoid assembly removed, the cargo hook being illustrated in the closed condition,

FIG. 3 is a similar view of the cargo hook in the open condition,

FIG. 4 is an elevation of the solenoid assembly when viewed from the side that confronts the housing of the cargo hook,

FIG. 5 is a side elevation of the cargo hook from the opposite side and illustrates the housing, the load beam and a release lever cover attached to the housing, the cargo hook being illustrated in the closed condition,

FIG. 6 is a view similar to FIG. 5 with the release lever cover removed, and

FIG. 7 is a similar view of the cargo hook in the open condition.

### DETAILED DESCRIPTION

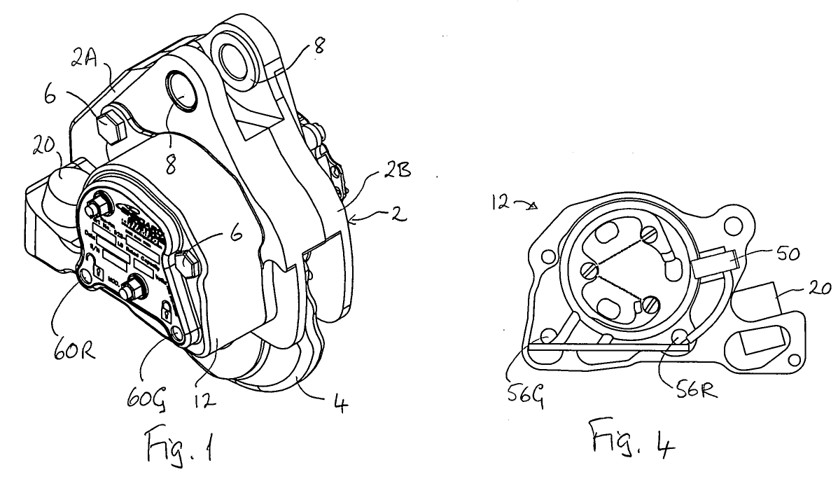

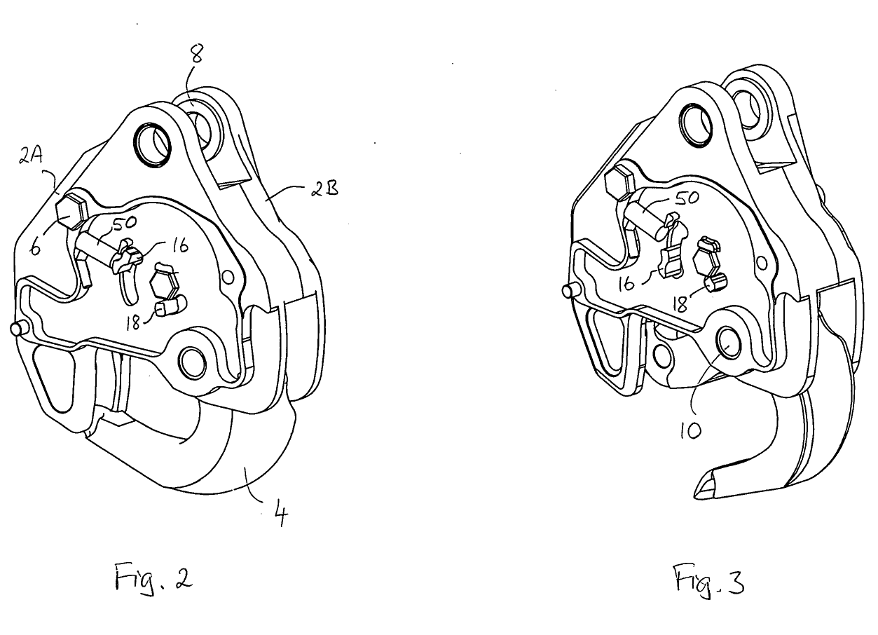

Referring to FIGS. 1-3, the illustrated keeperless cargo hook includes a housing 2 having two parts 2A, 2B that are secured together by appropriate fasteners including bolts 6. The two parts of the housing each include an attachment bushing 8 for attaching the cargo hook to a hook mount point secured to an aircraft. The cargo hook also includes a generally U-shaped load beam 4 that is pivotally mounted to the housing at a location 10 close to the base of the U by a bearing that allows the load beam to pivot relative to the housing about an axis parallel to the common axis of the bushings 8 between an open position (FIG. 3), in which a distal end of the lower limb of the load beam is spaced from the housing, and a closed position (FIG. 2), in which the distal end of the lower limb is located in a recess defined between the two parts 2A, 2B of the housing. When the load beam moves to its closed position, the upper limb of the load beam enters a cavity between the two parts of the housing 2. The cavity also accommodates a lock mechanism that interacts with the upper limb of the load beam for selectively locking the load beam in its closed position.

The lock mechanism, which is used in cargo hooks that are commercially available from Onboard Systems, Inc. of Vancouver, Wash., is operated when the load beam is pivoted towards its closed position by applying an upward force to the underside of the upper limb of the load beam. The upper limb transmits force to the lock mechanism, which transfers to a locked state in which it prevents pivotal movement of the load beam to the open position.

The lock mechanism includes a release cam member that is pivotable relative to the housing and has two arms 16 and 18 that project through respective slots in the housing part 2A. A solenoid assembly 12 is attached to the part 2A of the housing 2 and is operatively coupled to the lock mechanism through the two arms 16 and 18. The solenoid assembly 12 has a housing that contains a solenoid. The solenoid winding is connected to two power supply pins of a connector 20. The connector 20 is connected to a flexible cable (not shown), which includes wires for connecting the power supply pins of the connector to power and ground rails of the aircraft's electrical power distribution system through a solenoid control switch located in the aircraft's cockpit. The cable also includes wires for conveying control signals between the aircraft cockpit and the cargo hook.

When the solenoid control switch is actuated, the solenoid winding is electrically connected between the power and ground rails of the aircraft power distribution system and the solenoid is energized. In the event that the lock mechanism is in the locked state, the solenoid acts on the arms 16, 18 and turns the release cam member in the counterclockwise direction (as seen in FIG. 2). The lock mechanism is transferred to the released state and the load beam can pivot from the closed position to the open position.

Referring to FIGS. 5 and 6, the lock mechanism includes a release lever 24 that is located against the outer side of the housing part 2B and is pivotable about an axis that is parallel to the pivot axis of the load beam. Springs 26 (only one of which is shown in FIG. 6) urge the release lever in the counterclockwise direction as seen in FIG. 6. In normal operation, the release lever is covered by a release lever cover 28 that is secured to the part 2B of the housing. The release lever includes a manual release actuator 32 that projects outside the release lever cover 28. The release lever is formed with an aperture that receives an arm 34 of the release cam member and couples the manual release actuator 32 to the release cam member. Rotation of the release lever 24 in the clockwise direction (FIG. 5) by manual force applied to the manual release actuator 32 causes the release cam member to turn in the direction for transferring the lock mechanism to the released state.

A hydraulic slave cylinder 38 is attached to the part 2B of the housing and is hydraulically connected by a suitable hose 40 to a hydraulic master cylinder located in the cockpit of the aircraft. The master cylinder has a piston that can be actuated by a manual control. The slave cylinder has a piston 44 engaging a follower 48 of the release lever 24. In the event that the piston of the master cylinder is actuated, the piston 44 of the slave cylinder, acting through the follower 48, forces the release lever to rotate in the clockwise direction (FIG. 6) to the position associated with the released state of the lock mechanism. The load beam then pivots from the closed position to the open position.

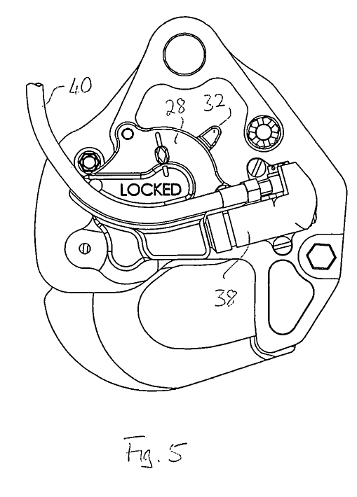

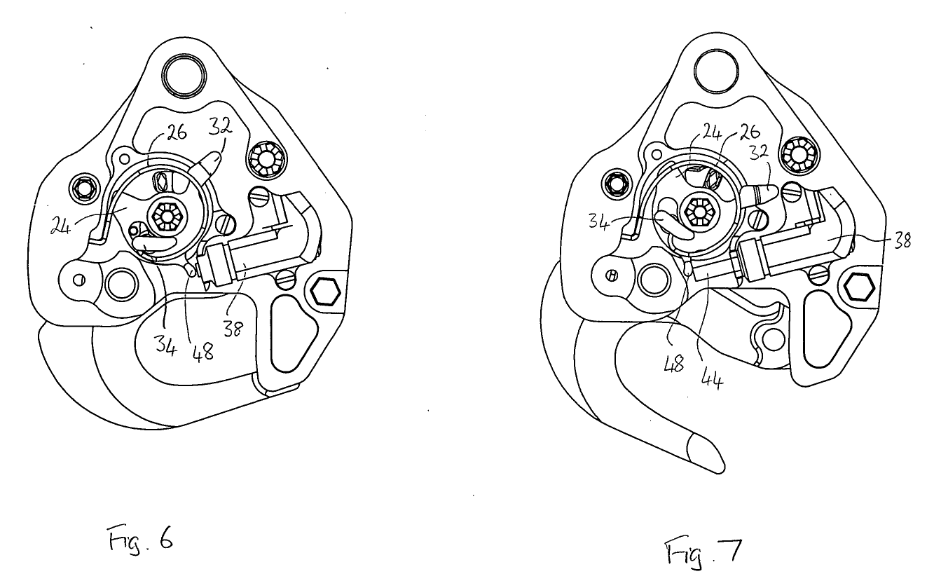

Referring again to FIGS. 2 and 3, when the release cam member rotates from the position associated with the released position to the position associated with the locked position, the arm 16 moves from the position shown in FIG. 3 to the position shown in FIG. 2. A proximity switch 50 mounted in the solenoid housing closes (is rendered conductive) when the arm 16 is in the position shown in FIG. 2. The proximity switch is connected to an electrical circuit that is mounted on a circuit board 54 (FIG. 4) located in the solenoid housing and includes a red LED 56R and a green LED 56G which are visible from the exterior of the solenoid housing through suitable openings 60R and 60G in the housing. The electrical circuit receives operating current via conductors included in the flexible cable that is connected to the connector 20. In the event that the arm 16 is in the position shown in FIG. 3, the proximity switch is open (non-conductive) and the electrical circuit does not drive the green LED and drives the red LED intermittently; whereas in the event that the arm 16 is in the position shown in FIG. 2, the proximity switch is closed and the electrical circuit drives the green LED and does not drive the red LED. Accordingly, the ground personnel are provided with a reliable indication of whether the lock mechanism is in the locked state or the released state, and need not infer that the lock mechanism is in the locked state based on the position of the load beam. Since one of the LEDs in energized in each state of the proximity switch, if neither LED is energized the ground personnel are apprised that the electrical switch is not operating correctly. In addition, control signal conductors included in the flexible cable relay information regarding the state of the proximity switch to a display in the aircraft cockpit and inform the pilot whether the cargo hook is properly closed.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A cargo hook for an aircraft, comprising:
a housing,
a load beam mounted in the housing and pivotable relative to the housing between a closed position and an open position,
a lock mechanism including a release member that is pivotable relative to the housing between a released position, in which the lock mechanism permits pivotal movement of the load beam from its closed position to its open position, and a locked position, in which the lock mechanism prevents movement of the load beam from its closed position to its open position,
a sensor for sensing whether the release member is in the locked position, and
an indicator circuit for providing different respective indications when the sensor senses that the release member is in the locked position and when the sensor does not sense that the release member is in the locked position.

2. A cargo hook according to claim 1, wherein the release member is pivotable relative to the housing and includes an arm that projects from the housing substantially parallel to the axis of pivotal movement of the release member, whereby the arm moves along an arcuate path when the release member moves between its locked position and its released position, and the sensor includes a proximity switch that is mounted adjacent the arcuate path and senses when the arm is proximate to the proximity switch.

3. A cargo hook according to claim 2, including a solenoid attached to the housing, and wherein the solenoid is coupled to a member that engages the arm of the release member for moving the release member from its locked position to its released position when the solenoid is energized.

4. A cargo hook according to claim 1, wherein the indicator circuit includes at least one light source and the light source has two different energization modes corresponding to said different respective indications.

5. A cargo hook according to claim 4, wherein the indicator circuit includes first and second light sources and each light source has two different energization modes corresponding to said different respective indications.

6. A cargo hook according to claim 4, wherein the indicator circuit includes first and second light sources, when the sensor senses that the release member is in the locked position the indicator circuit energizes the first light source continuously and does not energize the second light source, and when the sensor does not sense that the release member is in the locked position the indicator circuit does not energize the first light source continuously and energizes the second light source intermittently.

7. An aircraft cargo hook installation comprising:
a cargo hook including a housing, a load beam mounted in the housing and pivotable relative to the housing between a closed position and an open position, a lock mechanism including a release member that is pivotable relative to the housing between a released position, in which the lock mechanism permits pivotal movement of the load beam from its closed position to its open position, and a locked position, in which the lock mechanism prevents movement of the load beam from its closed position to its open position, and a sensor for sensing whether the release member is in the locked position, and
a display located interiorly of the aircraft and connected operatively to the sensor for providing different respective indications when the sensor senses that the release member is in the locked position and when the sensor does not sense that the release member is in the locked position.

8. A cargo hook installation according to claim 7, wherein the cargo hook includes an indicator circuit connected to the sensor and entering a first state when the sensor senses that the release member is in the locked position and a second state when the sensor does not sense that the release member is in the locked position, and the indicator circuit is connected to the display.

9. An aircraft cargo hook installation comprising:
a cargo hook including a housing, a load beam mounted in the housing and pivotable relative to the housing between a closed position and an open position, and a lock mechanism including a release member that is movable relative to the housing between a released position, in which the lock mechanism permits pivotal movement of the load beam from its closed position to its open position, and a locked position, in which the lock mechanism prevents movement of the load beam from its closed position to its open position, a slave hydraulic cylinder attached to the housing and having a piston that is in force transmitting relationship with the release member when the release member is in the locked position and the slave hydraulic cylinder is actuated, for moving the release member to its released position, a master hydraulic cylinder that can be actuated from a location interiorly of the aircraft, and
an hydraulic hose connecting the master hydraulic cylinder to the slave hydraulic cylinder for communicating hydraulic pressure between the master hydraulic cylinder and the slave hydraulic cylinder, whereby actuation of the master hydraulic cylinder effects actuation of the slave hydraulic cylinder.

10. A cargo hook installation according to claim 9, including a release lever for transmitting force from the piston of the slave hydraulic cylinder to the release member.

11. A cargo hook installation according to claim 9, wherein the release member is pivotable relative to the housing.
